(19) United States
(12) Patent Application Publication
(10) Pub. No.: US 2007/0154135 A1
(43) Pub. Date: Jul. 5, 2007

(54) Connector and indicator thereof

(75) Inventors: Ru-Kuen Huang, Taoyuan Hsien (TW); Chieh-Cheng Chen, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/648,784

(22) Filed: Jan. 3, 2007

(30) Foreign Application Priority Data
Jan. 3, 2006 (TW) 095100197

(51) Int. Cl. G02B 6/26; G02B 6/42

(52) U.S. Cl. 385/15; 385/31

(57) ABSTRACT

A connector includes an indicator and a connector body. The indicator includes a light-emitting part and a light-guiding structure. The light-guiding structure guides the light emitted from the light-emitting part to one end of the light-guiding structure, which is away from the light-emitting part. The portion of the light-guiding structure is a hollow structure. The connector body has an accommodating space in which at least one portion of the light-guiding structure is disposed.

### DETAILED DESCRIPTION OF THE INVENTION

### Cross Reference to Related Applications

This Non-provisional application claims priority under 35 U.S.C. §119(a) on Patent Application No(s). 095100197 filed in Taiwan, Republic of China on Jan. 3, 2006, the entire contents of which are hereby incorporated by reference.

### BACKGROUND OF THE INVENTION

1. Field of Invention

The invention relates to an indicator and, in particular, to an indicator used in a connector.

2. Related Art

Light-emitting diodes (LED) have the features of vibration-resistance, long life, power efficiency and low heat production, so that they have been widely used in all kinds of electronic products as indicators, light sources, or backlit sources.

As electronic devices become more compact, highly dense, high-speed, and multi-functional, electromagnetic interference (EMI) between different elements has significant effects on the efficiency and reliability of the devices.

The connector, such as an RJ-45 connector, usually uses an LED as its indicator for indicating the operation status. However, as the operating speed of the RJ-45 connector is greatly increased from 10 Mbps to the current 100 Mbps or 1 Gbps, the problem of EMI becomes very serious. With reference to FIG. 1, an indicator 11 is disposed at the rear part of a conventional connector 12. The case of the connector 12 is made of a transparent material for transmitting light. Since the indicator 11 is disposed inside the connector 12, it is likely to induce EMI with the electrical elements (such as filter coils, transformers, etc) inside the connector 12. This reduces the efficiency and reliability of the connector 12 or the electrical elements therein.

Therefore, it is an important subject to provide a connector along with its indicator that can avoid EMI with the electronic product coupled thereto.

### SUMMARY OF THE INVENTION

In view of the foregoing, the invention is to provide a connector and an indicator thereof that do not cause EMI with the electronic product used with them.

To achieve the above, the invention discloses a connector, which includes an indicator and a connector body. The indicator includes a light-emitting part and a light-guiding structure. The light-guiding structure guides the light emitted from the light-emitting part to one end of the light-guiding structure, which is away from the light-emitting part. At least one portion of the light-guiding structure is a hollow structure. The connector body has an accommodating space in which at least one portion of the light-guiding structure is disposed.

To achieve the above, the invention also discloses an indicator, which is connected to a connector and has a light-emitting part and a light-guiding structure. The light-guiding structure guides the light emitted from the light-emitting part to one end of the light-guiding structure, which is away from the light-emitting part. At least one portion of the light-guiding structure is a hollow structure.

As mentioned above, at least one part of the light-guiding structure of the indicator is disposed inside the accommodating space of the connector body for guiding light. Thus, the light-emitting part of the indicator does not need to be disposed inside the connector body. Therefore, the EM radiation from the light-emitting part can be effectively blocked from interfering with the electronic elements inside the connector body. The efficiency and reliability of the connector and electronic elements is thus improved. In addition, the indicator of the invention includes the light-guiding structure, which is used for transmitting light or light signals, so the manufacturing cost can be greatly reduced with improved indicator efficiency.

### BRIEF DESCRIPTION OF THE DRAWINGS

The invention will become more fully understood from the detailed description given herein below illustration only, and thus is not limitative of the present invention, and wherein:

FIG. 1 is a cross-sectional view of the conventional connector;

FIG. 2a is a three-dimensional exploded view of the indicator according to an embodiment of the invention;

FIG. 2b is a three-dimensional exploded view of the indicator according to another embodiment of the invention;

FIG. 3 is a three-dimensional exploded view of the connector according to an embodiment of the invention;

FIG. 4 is a cross-sectional view of the connector according to another embodiment of the invention; and

FIG. 5 is a cross-sectional view of the connector according to yet another embodiment of the invention.

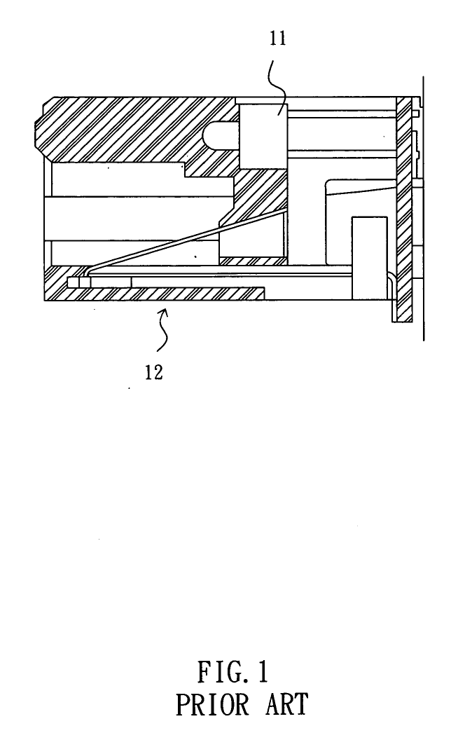

### DETAILED DESCRIPTION OF THE INVENTION

The present invention will be apparent from the following detailed description, which proceeds with reference to the accompanying drawings, wherein the same references relate to the same elements.

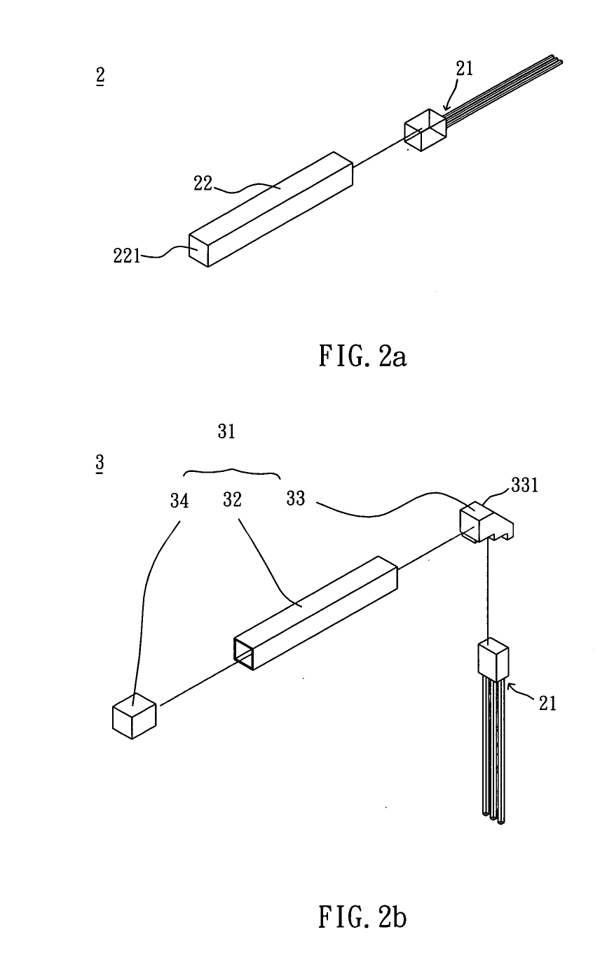

With reference to FIG. 2a, an indicator 2 according to a preferred embodiment of the invention includes a light-emitting part 21 and a light-guiding structure 22. The light-emitting part 21 can be an LED, an organic LED (OLED), or any other light-emitter as a light source.

At least one portion of the light-guiding structure 22 is a hollow structure. More explicitly, the light-guiding structure 22 can be a polygonal tube or a circular tube. One end of the light-guiding structure 22 that is away from the light-emitting part 21 can even be a closed end 221. The light-guiding structure 22 and the light-emitting part 21 correspond to each other. The light emitted from the light-emitting part 21 is guided to the end of the light-guiding structure 22 that is away from the light-emitting part 21 (e.g., the closed end 221). The light-guiding structure 22 (e.g., its sidewall) can be a transparent, semi-transparent, or opaque material. The inner or outer side of the sidewall can has a reflective layer, a light-absorbing layer, a heat-resistant layer, or an anti-electromagnetic wave layer according to needs.

As shown in FIG. 2b, another indicator 3 of the invention includes a light-emitting part 21 and a light-guiding structure 31. The light-guiding structure 31 includes a hollow structure 32, a mediator 33, and a display part 34. The hollow structure 32 (e.g., its sidewall) can be made of a transparent, semi-transparent, or opaque material. The inner or outer side of the sidewall can has a reflective layer, a light-absorbing layer, a heat-resistant layer, or an anti-electromagnetic wave layer according to needs.

Furthermore, one end of the mediator 33 is connected to the light-emitting part 21. The other end of the mediator 33 is connected to the hollow structure 32. The mediator 33 is as an intermediate mediator between the light-emitting part 21 and the hollow structure 32. The mediator 33 can be an independent structure, or integrally formed with the light-emitting part 21 or the hollow structure 32 as a single piece. When the light-emitting part 21, the mediator 33, and the hollow structure 32 are positioned on different lines, the mediator 33 has at least one slant or curved surface 331 to reflect or deflect the light emitted from the light-emitting part 21 to the hollow structure 32. The mediator 33 can have a line-shaped, an L-shaped, an S-shaped or a U-shaped profile. The mediator 33 can be a solid structure or a hollow structure. The inner or outer side of the mediator 33 can have a reflective layer, a light-absorbing layer, a heat-resistant layer, or an anti-electromagnetic wave layer according to needs.

The display part 34 is connected to the end of the hollow structure 32 that is far from the light-emitting part 21. It is made of a transparent or semi-transparent material. The display part 34 can be a block, a polyhedron, or a structure or a plate with at least one protruded or pitted point. The hollow structure 32 guides the light emitted from the light-emitting part 21 to the display part 34.

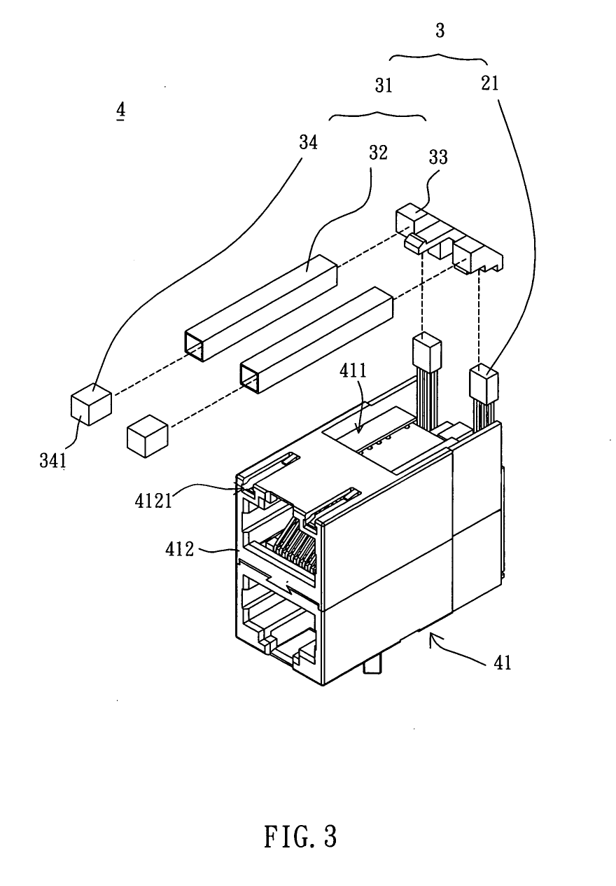

As illustrated in FIG. 3, the connector 4 according to a preferred embodiment of the invention consists of two indicators 3 and one connector body 41. The mediator 33 is integrally formed as a single piece and connected with two hollow structures 32 or two light-emitting parts 21. The connector body 41 has at least one connecting terminal, other electronic elements, two accommodating spaces 411 and a front surface 412. The light-emitting part 21 is disposed at the exterior of the connector body 41. At least one portion of the hollow structure 32 is disposed inside the accommodating space 411. The display part 34 is disposed at the front end of the connector body 41. Its one surface 341, away from the light-emitting part 21, is roughly leveled with an opening 4121 of the front surface 412. The surface 341 of the display part 34 can protrude or be recessed from the opening 4121.

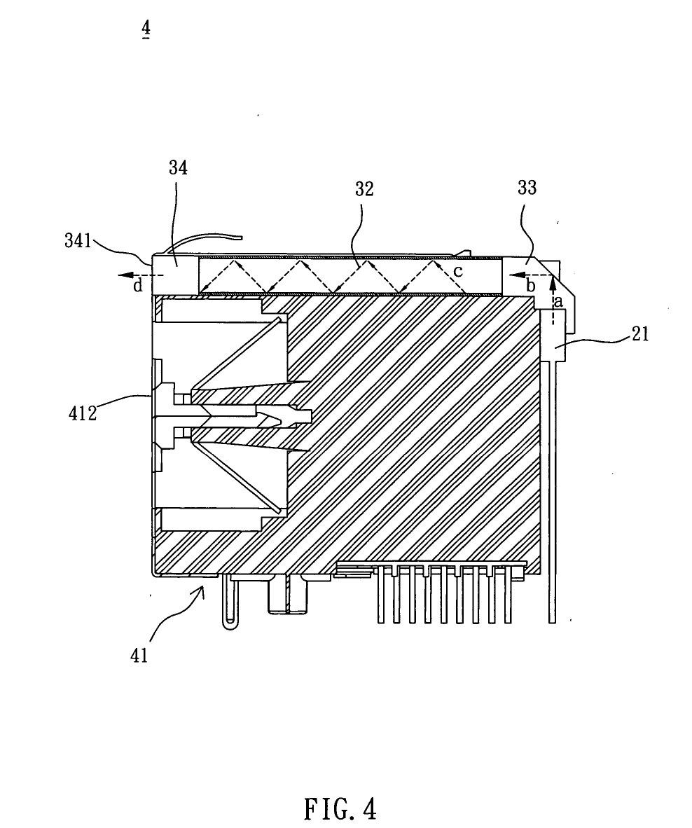

With reference to FIG. 4, the light (optical path a) emitted from the light-emitting part 21 is transmitted through the mediator 33 (optical path b), the hollow structure 32 (optical path c) to the surface 341 (optical path d) of the display part 34 for showing the operational status of the connector 4. In this embodiment, the connector 4 can be an RJ-45, RJ-11, or any other type of connector.

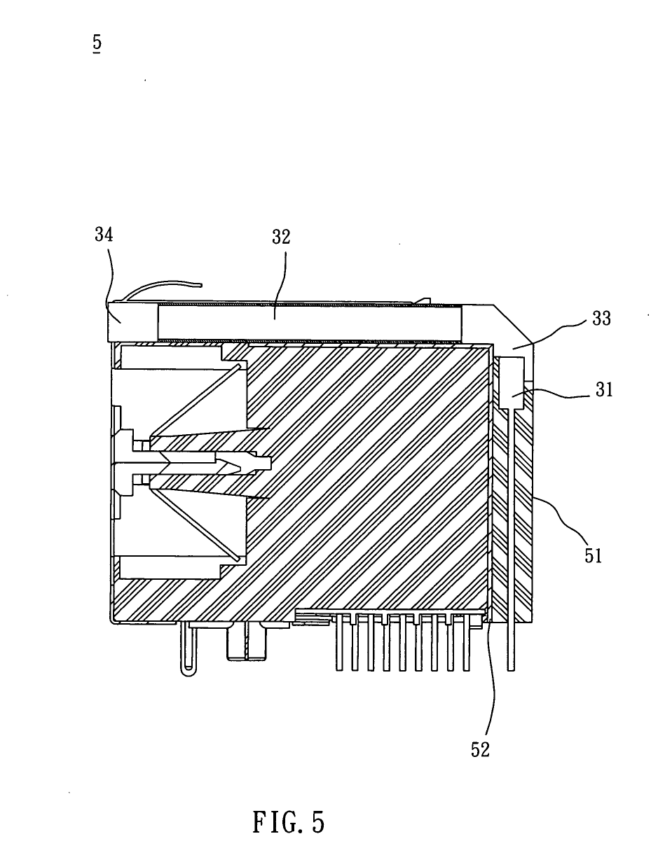

As shown in FIG. 5, another connector 5 of the invention includes a blocking part 52 and a case 51. The blocking part 52 encloses the connector body 41. The case 51 encloses the blocking part 52. The accommodating space 411 is between the case 51 and the blocking part 52. Additionally, the case 51 and the connector 5 are separable structures. Since the indicator 3 is disposed between the case 51 and the blocking part 52 (i.e., the accommodating space 411), the indicator 3 is thus protected from being damaged.

In summary, at least one portion of the light-guiding structure of the indicator is disposed inside the accommodating space of the connector body for guiding light. Thus, the light-emitting part of the indicator does not need to be disposed inside the connector body. Therefore, the EM radiation from the light-emitting part can be effectively blocked without interference with the electronic elements inside the connector body. The efficiency and reliability of the connector and electronic elements is thus improved.

In addition, the indicator of the invention includes the light-guiding structure, which is used for transmitting light or light signals, so the manufacturing cost can be greatly reduced while preserving the efficiency of the indicator.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A connector comprising:
an indicator having at least one light-emitting part and at least one light-guiding structure, wherein the light-guiding structure guides light emitted from the light-emitting part to one end of the light-guiding structure and at least one portion of the light-guiding structure is a hollow structure; and
a connector body having an accommodating space for receiving at least one portion of the light-guiding structure therein.

2. The connector of claim 1, wherein the light-guiding structure is connected with the light-emitting part.

3. The connector of claim 1, wherein the light-guiding structure has a reflective layer, a light-absorbing layer, a heat-resistant layer, or an anti-electromagnetic wave layer on a sidewall thereof.

4. The connector of claim 1, wherein the light-guiding structure is a closed end away from the light-emitting part.

5. The connector of claim 1, wherein the light-guiding structure further comprises a display part connected to the end of the light-guiding structure, and made of a transparent material or a semi-transparent material.

6. The connector of claim 5, wherein the display part is a block, a polyhedron, or a structure with a plurality of protruded or pitted points.

7. The connector of claim 5, wherein the connector body has an opening and one surface of the display part is protruded from, recessed from or substantially leveled with the opening.

8. The connector of claim 1, wherein the light-guiding structure further comprises a mediator having one end of the mediator connected to the light-emitting part, and another end of the mediator connected to the light-guiding structure.

9. The connector of claim 8, wherein the mediator is integrally formed with the light-emitting part and/or the light-guiding structure as a single piece.

10. The connector of claim 8, wherein the mediator has at least a slant surface or a curved surface for reflecting or deflecting the light emitted from the light-emitting part to the light-guiding structure.

11. The connector of claim 8, wherein the mediator has a line-shaped, an L-shaped, an S-shaped or a U-shaped profile.

12. The connector of claim 1, further comprising:
a blocking part enclosing the connector body; and
a case enclosing the blocking part, wherein the indicator is disposed between the blocking part and the case.

13. The connector of claim 12, wherein the case and the connector body are separated structures.

14. The connector of claim 1, wherein the accommodating space is outside the connector body.

15. The connector of claim 1, wherein the light-guiding structure is a polygonal tube or a circular tube.

16. The connector of claim 1, wherein the light-guiding structure is made of a transparent material, a semi-transparent material, or an opaque material.

17. The connector of claim 1, wherein the light-emitting part and the light-guiding structure are positioned on different lines.

18. An indicator comprising:
at least one light-emitting part; and
at least one light-guiding structure, wherein the light-guiding structure guides a light emitted from the light-emitting part to one end of the light-guiding structure and at least one portion of the light-guiding structure is a hollow structure.

19. The indicator of claim 18, wherein the light-guiding structure has a reflective layer, a light-absorbing layer, a heat-resistant layer, or an anti-electromagnetic wave layer on a sidewall thereof.

20. The indicator of claim 18, which cooperates with a connector body to compose a connector, the connector comprising:
a blocking part enclosing the connector body; and
a case enclosing the blocking part, wherein the indicator is disposed between the blocking part and the case.
